(19) United States
(12) Patent Application Publication
(10) Pub. No.: US 2007/0214983 A1
(43) Pub. Date: Sep. 20, 2007

(54) Method and apparatus for punching a printing plate

(76) Inventor: Chang J. Yee, Stow, MA (US)

Correspondence Address: HOWARD J. GREENWALD P.C., 349 W. COMMERCIAL STREET SUITE 3075, EAST ROCHESTER, NY, 14445-2408, US

(21) Appl. No.: 11/375,512

(22) Filed: Mar. 14, 2006

(51) Int. Cl. B41C 3/08

(52) U.S. Cl. 101/401.1

(57) ABSTRACT

Disclosed in this specification is a plate punching assembly, comprising a base with a footprint, wherein the base has a slot configured to receive a printing plate. The footprint is comprised of a first actuator configured to actuate a first bore, thus punching through the slot and into a first chaff disposal opening. The footprint also has a second actuator similarly configured. The first and second actuators are independently activated. In one embodiment, a chaff disposal collector is disposed over the footprint such that the chaff is collected in a secure fashion.

### FIELD OF THE INVENTION

This invention relates generally to printing devices and more particularly to planographic plate making. In one embodiment, a plate punching apparatus is provided. In another embodiment, a method for the safe collection of the chaff produced in the punching process is disclosed.

### BACKGROUND OF THE INVENTION

Current printing technology utilizes a variety of printing methodologies and assemblies. One such printing system is the so-called “Computer-to-Plate” (CTP) system. Reference may be had to U.S. Pat. No. 6,684,783 to Salvestro (Method for imaging a media sleeve on a computer-to-plate imaging machine); U.S. Pat. Nos. 6,662,723; 6,526,886; 6,523,473; 6,523,472; 6,457,413; all to Loccufier (Computer-to-plate by ink jet); U.S. Pat. Nos. 5,992,324 and 5,738,014; both to Rombult (Method and apparatus for making lithographic printing plates in an automated computer to plate imaging system); and the like. The content of each of the aforementioned patents is hereby incorporated by reference into this specification.

The plates used in a computer-to-plate system are often notched before being transferred to a printer. The notches on the plate are punched in a predetermined pattern that is designed to match the notches found within the printer. Such a mated-notch configuration ensures that the plate fits within the printer properly. Precise placement of these plates within the printer is required—especially when high resolution, color images are to be printed. Reference may be had to United States patent application 2005/0120899A1 to Gelbart (Method for Automated Platemaking), U.S. Pat. No. 6,112,664 to Naniwa (Plate Making Apparatus with a Cutter and Punch Mechanism Formed in One Piece); and European Patent Application 0,985,528 to Okamura (Improvements in and Relating to the Manufacture of Printing Plates). The content of each of the aforementioned patents and patent applications is hereby incorporated by reference into this specification.

The printing art commonly utilizes certain notching patterns that are designed to match certain printers. Many notching patterns have been standardized, but there is still a wide variety of patterns found in the art. Examples of common patterns may be found in the technical brochure produced by SCITEX for their Lotem 800V.

Commercial printing facilities often desire to purchase additional printing equipment. The facility managers must use greater care to ensure all of the equipment they purchase utilizes the same, or a compatible, notching pattern. For example, should the facility be equipped with a new printer that utilizes Bacher style notches, but their existing equipment utilizes a Komori style notch system, the resulting incompatibility will necessitate the purchase of additional equipment that obviates the incompatibility.

The prior art has attempted to solve this incompatibility problem by producing plate punching devices. The printing plate is disposed in such a device and a suitable punching pattern is thereafter punched into the plate. In this manner, one fabricates the desired notch pattern at the printing facility itself. However, the act of punching a notch in the plate results in the production of chaff particles. These chaff particles are of great concern to printers, as a single piece of loose chaff can easily disrupt the operation of the printing assembly, and thereby cause the printing process to stop.

It is an object of this invention to provide at least one of the following; an apparatus and/or method for punching a notch in a printing plate which is an improvement over prior art punching machines; and/or a process and/or apparatus for collecting the chaff produced by such a printing process.

### SUMMARY OF THE INVENTION

In accordance with the present invention, there is provided a plate punching assembly, comprising a base with a footprint, wherein the base has a slot configured to receive a printing plate. The footprint is comprised of a first actuator configured to actuate a first bore, thus punching through the slot and into a first chaff disposal opening. The footprint also has a second actuator similarly configured. The first and second actuators are independently activated. In one embodiment, a chaff disposal collector is disposed over the footprint such that the chaff is collected in a secure fashion. The technique described above is advantageous because it permits the chaff to be easily and safely collected after a plate is punched. The technique is also advantageous in that the punching assembly is more compact than prior art assemblies and can provide a more varied array of notch patterns.

### BRIEF DESCRIPTION OF THE DRAWINGS

The invention will be described by reference to the following drawings, in which like numerals refer to like elements, and in which:

FIG. 1 is a perspective view of a computer-to-plate assembly for use with the present invention;

FIG. 2 is another perspective view of the assembly of FIG. 1 wherein the plate punching assembly is illustrated;

FIG. 3 is a depiction of one plate punching assembly of the present invention;

FIG. 4 is an illustration of the footprint of the plate punching assembly of FIG. 3;

FIG. 5 another illustration of the plate punching assembly of FIG. 3;

FIG. 6 is a schematic view of one plate punching assembly of the present invention;

FIG. 7 is an illustration of one footprint for use with the present invention;

FIG. 8 is an illustration of another footprint for use with the present invention;

FIG. 9 is a depiction of another footprint for use in the plate punching assembly of the present invention;

FIG. 10 shows yet another such footprint; and

FIG. 11 is a schematic diagram of one method for collecting chaff.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements.

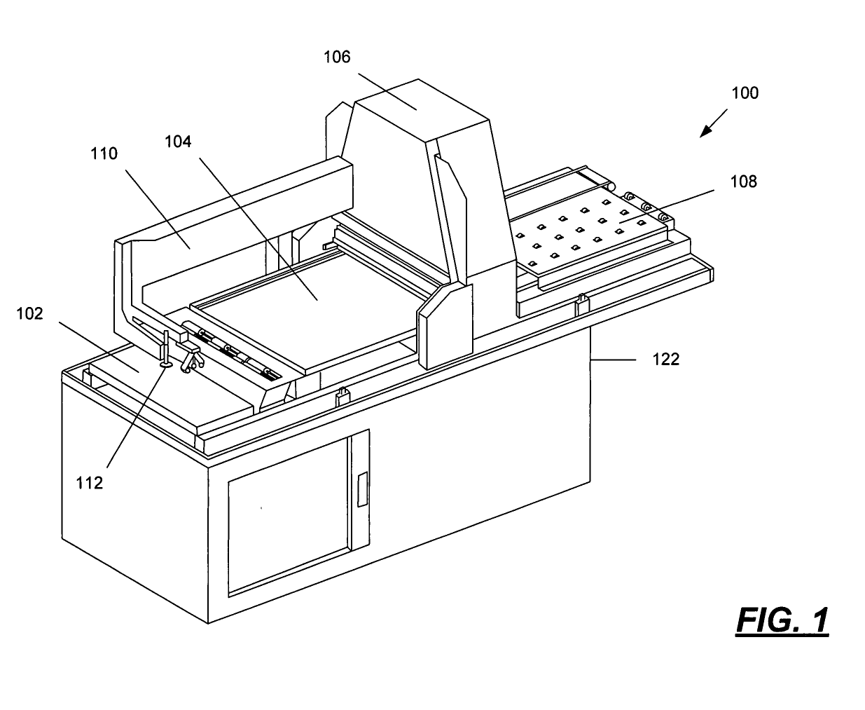

FIG. 1 is a depiction of computer-to-plate assembly 100. Assembly 100 is comprised of a cartridge receiver 102, a registration area 104, and an arm 110 equipped with a plate moving device 112 that is configured to move plates from cartridge receiver 102 to registration area 104. Reference may be had to U.S. Pat. No. 6,726,433 to Blake (Apparatus for Loading and Unloading a Supply of Plates in an Automated Plate Handler), the content of which is hereby incorporated by reference into this specification. The entire assembly rests atop supporting structure 122.

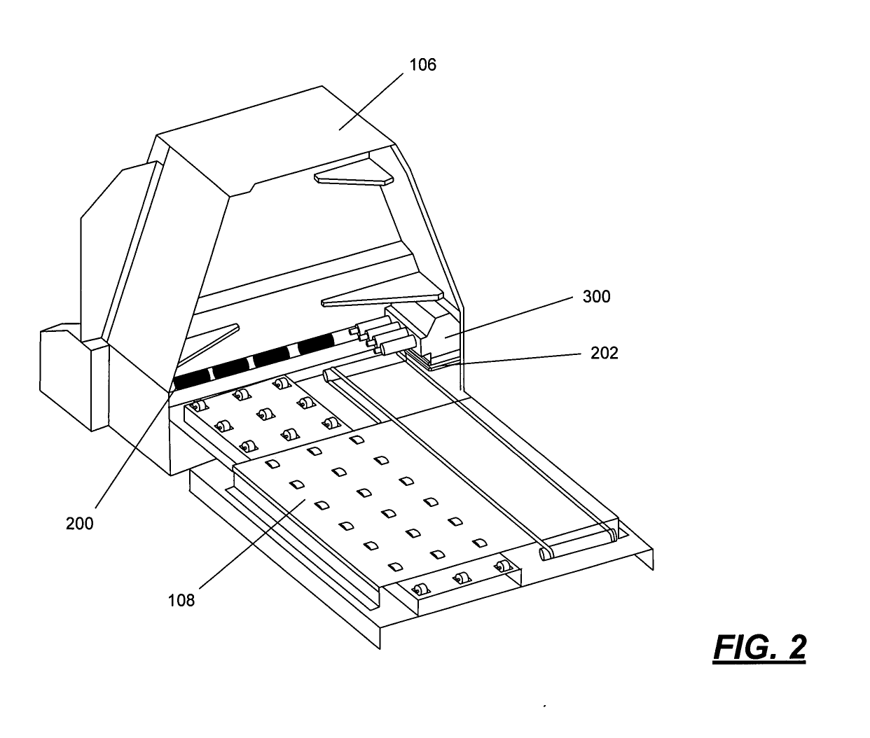

As depicted in FIG. 1, when a plate is disposed on registration area 104 it is properly positioned (i.e. “registered’) on registration area 104 in preparation for feeding the plate to imager 106, wherein the plate will be imprinted with the desired image. Methods for registering plates are well known in the art. Reference may be had to U.S. Pat. No. 5,255,607 to Nishiyama (Method and Apparatus for Maintaining Registration When Making a Printing Plate); U.S. Pat. No. 6,130,702 to Ganton (Method for Reliable Loading of Unexposed Printing Plates); U.S. Pat. No. 4,566,194 to Tsunoda (Press Plate Positioning Apparatus for Automatic Drawing Machine); and European Patent Application 0,950,925 to Naniwa (Plate Making Apparatus, Printing Method and Printing Apparatus, Packing Sheet Material for Printing Plate Material, and Plate Material Placement Method and Apparatus); and the like. The content of each of the aforementioned patents is hereby incorporated by reference into this specification. Once the plate is properly aligned, it is feed into the receiving rollers 200 (see FIG. 2) of imager 106.

FIG. 2 is an illustration of imager 106 shown from an alternate view. The walls of imager 106 have been removed for the sake of illustration. The imaged plate is passed through imager 106 by the action of rollers 200. Rollers 200 are preferably precision nip rollers. Such precision nip rollers securely grip the imaged plate and can accurately control the motion of such plate. After imaging, the resulting plate is disposed within slot 202 of plate punching assembly 300. By accurately controlling rollers 200, the plate can be moved forward a predetermined distance and thereafter a first punch is made by assembly 300. The plate can then be moved a second predetermined distance and thereafter a second punch is made. By repeating this process, any number of punches may be made at precise, predetermined locations. In one embodiment, the plate punching assembly 300 is disposed within imager 106. In another embodiment, plate punching assembly 300 is disposed prior to the imager 106 (for example, after registration area 104). In yet another embodiment, the plate punching assembly 300 is disposed after, but external to, imager 106. After one or more notches have been punched in the imaged plate, the plate is placed atop transporter 108, which conveys the imaged plate to another processing device for eventual printing. The details of this transporter are disclosed in applicant's co-pending patent application U.S. Ser. No. 11/325,909, filed on Jan. 5, 2006, the content of which is hereby incorporated by reference into this specification.

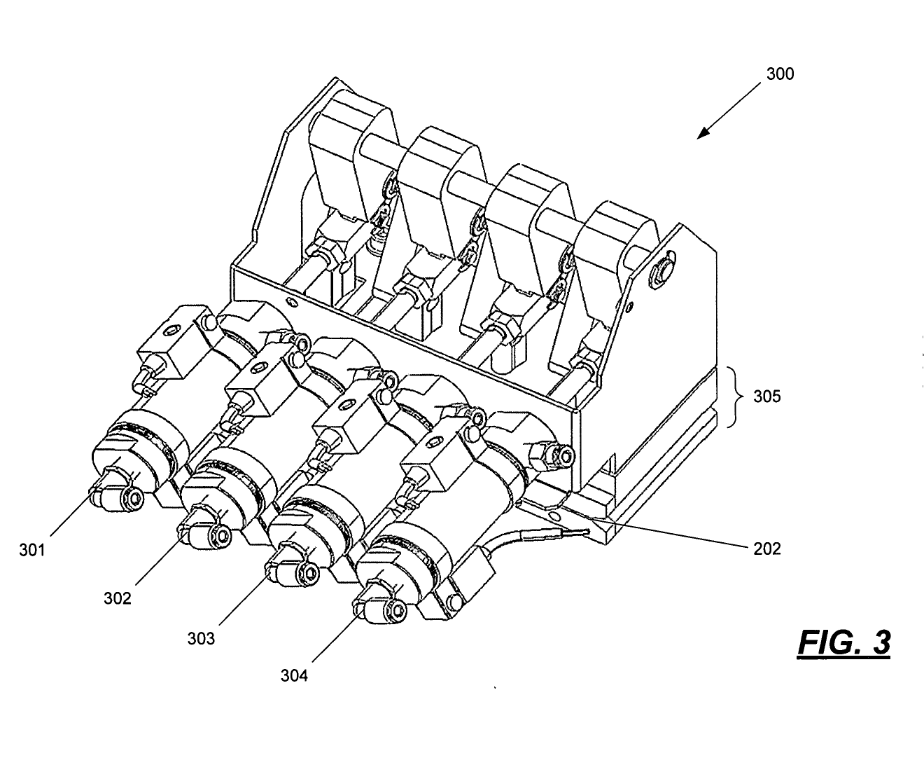

FIG. 3 depicts plate punching assembly 300 which is comprised of base 305 and actuators 301-304. In the embodiment depicted, actuators 301-304 are air actuators. Suitable air actuators are known to those skilled in the art. Reference may be had to U.S. Pat. No. 3,672,260 to Gachot (Compressed-Air Actuator); U.S. Pat. No. 5,003,864 to Dyer (Geared Air Actuator); U.S. Pat. No. 5,161,502 to Fritz (Method and Arrangement for Setting an Idle Air Actuator); U.S. Pat. No. 5,454,254 to Mueller (Can Body Maker Apparatus with Air Actuator Redraw Mechanism); U.S. Pat. No. 5,941,509 to Avesian (Clamp Assembly for Air Actuator); U.S. Pat. No. 6,513,418 to Simmons (Air Actuator); U.S. Pat. No. 6,663,360 to Kyer (Fluid Injection pump with Internal Air Actuator Valve); U.S. Pat. No. 6,679,160 to Wise (Dual Air Actuator for Operating an Air Chuck); and the like. The content of each of the aforementioned patents is hereby incorporated by reference into this specification. Base 305, in turn, is comprised of slot 202. Slot 202 is configured to permit a printing plate to be disposed in such slot. Activation of one or more of the actuators 301-304 causes a bore (not shown in FIG. 3) to punch a hole in the plate. The shape of the bore determines the shape of the resulting hole in the plate. Thus, by choosing which bore to use and selecting which locations on the pate to punch, a predetermined notching pattern can be formed.

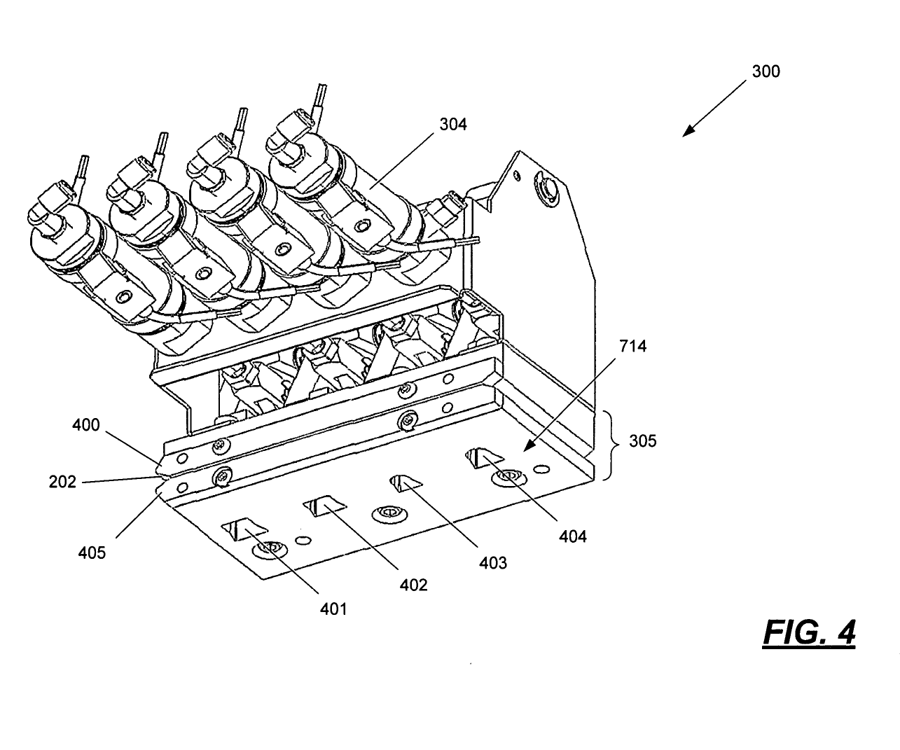

FIG. 4 shows plate punching assembly 300 from the bottom. From this perspective upper flange 400 and lower flange 405 of slot 202 are visible. As the plate emerges from rollers 200, these flanges help to guide it into slot 202. Also visible from this perspective is footprint 714 of the base 305. Footprint 714 is comprised of first chaff disposal opening 401, second chaff disposal opening 402, third chaff disposal opening 403, and fourth chaff disposal opening 404. It is advantageous that these chaff disposal openings 401-404 are in close proximity, as this promotes the safe collection of the chaff. Should the chaff disposal openings be spread over a larger area, as is the case in many prior art designs, it becomes increasingly difficult to safely contain the chaff.

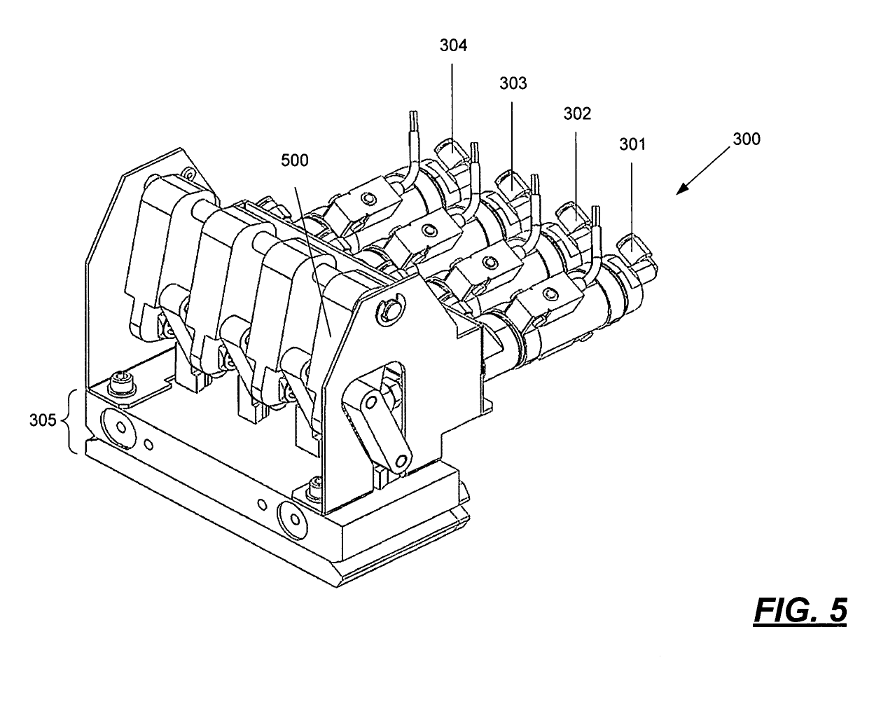

FIG. 5 illustrates plate punching assembly 300 from the backside. From this view, it is clear that plate punching assembly 300 is comprised of base 305, actuators 301-304, and linkage 500. In the embodiment depicted, plate punching assembly 300 has four actuators 301-304, each of which may be activated independently. In another embodiment, two such actuators are present.

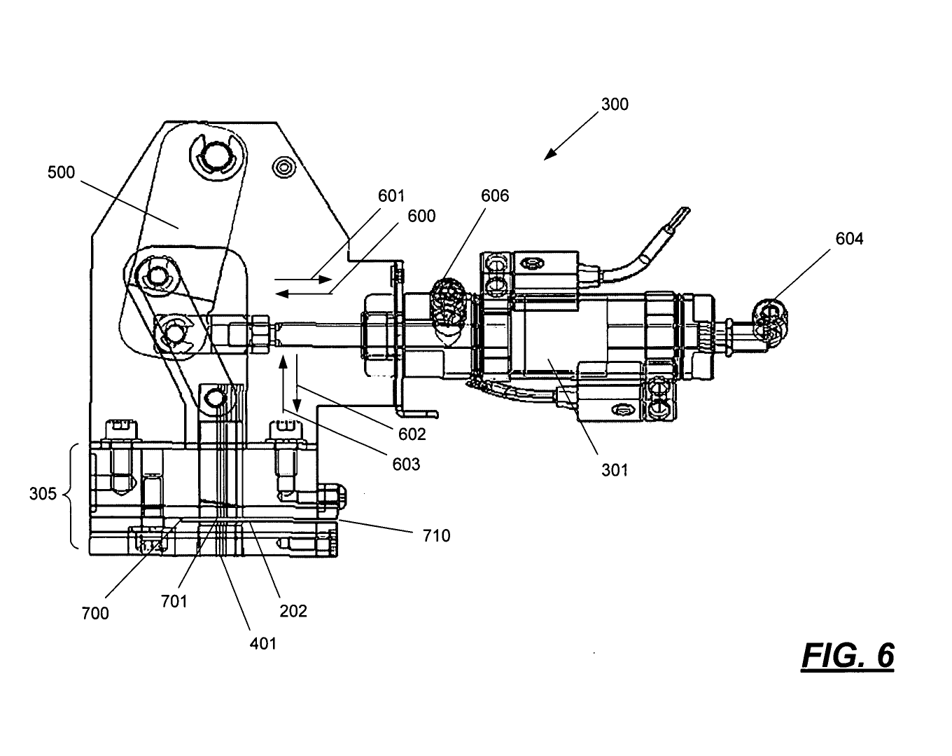

Independent activation of the actuators 301-304 is advantageous in that it permits the plate punching assembly 300 to punch a single hole in the plate, move the plate, and thereafter punch a second hole. Such a configuration ensures that the chaff disposal openings 401-404 (see FIG. 4) are in close proximity—the plate moves to the location of the bore—thus the bores can be kept in a relatively compact arrangement. This compact arrangement permits easy collection of the chaff. In another embodiment, the activation of the actuators 301-304 is paired such that more than one, but fewer than all, of the actuators are activated at a given moment. For example, actuators 301 and 303 may be activated while actuators 302 and 304 remain un-activated. In another embodiment, the actuators are activated independently, such that at least two actuators are used in a given punching cycle, but no more than one actuator is activated at a given moment. Such actuators 301-304 may be independently activated in any order. For example, in one embodiment actuator 301 is activated, the printing plate is subsequently moved and thereafter actuator 304 is activated. In another embodiment, actuator 302 and actuator 303 are independently activated in a similar fashion. In another embodiment, actuators 301-304 are each independently actuated in a given punching cycle. Other combinations of hole punching patterns would be appreciated by those skilled in the art after reading this specification. Such combinations are considered within the scope of this invention. The punching of such holes is best illustrated in FIG. 6.

FIG. 6 depicts a sectional profile of plate punching assembly 300 wherein the internal mechanisms are visible. In the embodiment depicted, actuator 301 is comprised of first air inlet 604 and second air inlet 606. The actuator 301 is configured to actuate bore 701, thus punching through slot 202 and into chaff disposal opening 401. Actuator 301 is mechanically connected to linkage 500 such that their motions are coupled. Activation of actuator 301 by first air inlet 604 causes the actuator to move in first horizontal direction 600 for a certain air cylinder stroke distance. This motion causes linkage 500 to move which, in turn, causes bore 701 to travel in first vertical direction 602 for a certain punch stroke distance, thus punching through slot 202 and into first chaff disposal opening 401. In one embodiment, the air cylinder stroke distance is about 0.8 inches and the punch stroke distance is about 0.1 inches. In such an embodiment, the stroke ratio, which is the punch stroke distance divided by the air cylinder stroke distance, is 0.125. In another embodiment, the stroke ratio is from about 0.1 to about 5. In another embodiment, the stroke ratio is from about 0.1 to about 1. To reset bore 701, actuator 301 is activated by second air inlet 606 that causes the actuator to move in second horizontal direction 601. This causes the linkage 500 to move bore 701 in second vertical direction 603, thus returning bore 701 to its original position. As would be apparent to one skilled in the art, the linkage 500 provides a mechanical advantage which increases the force that is delivered by bore 701.

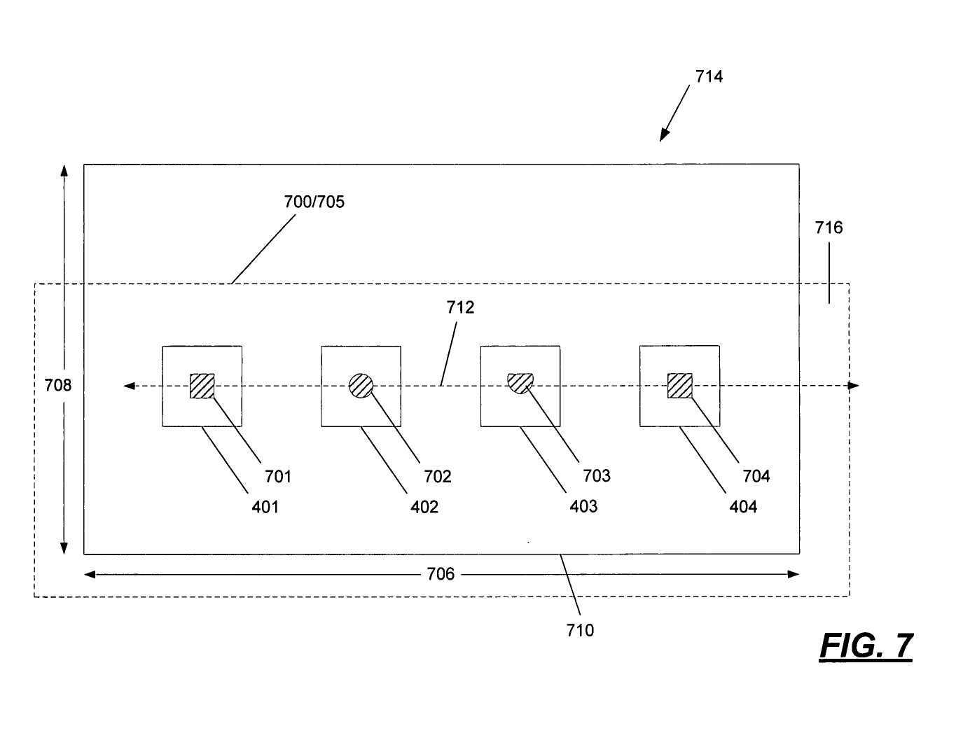

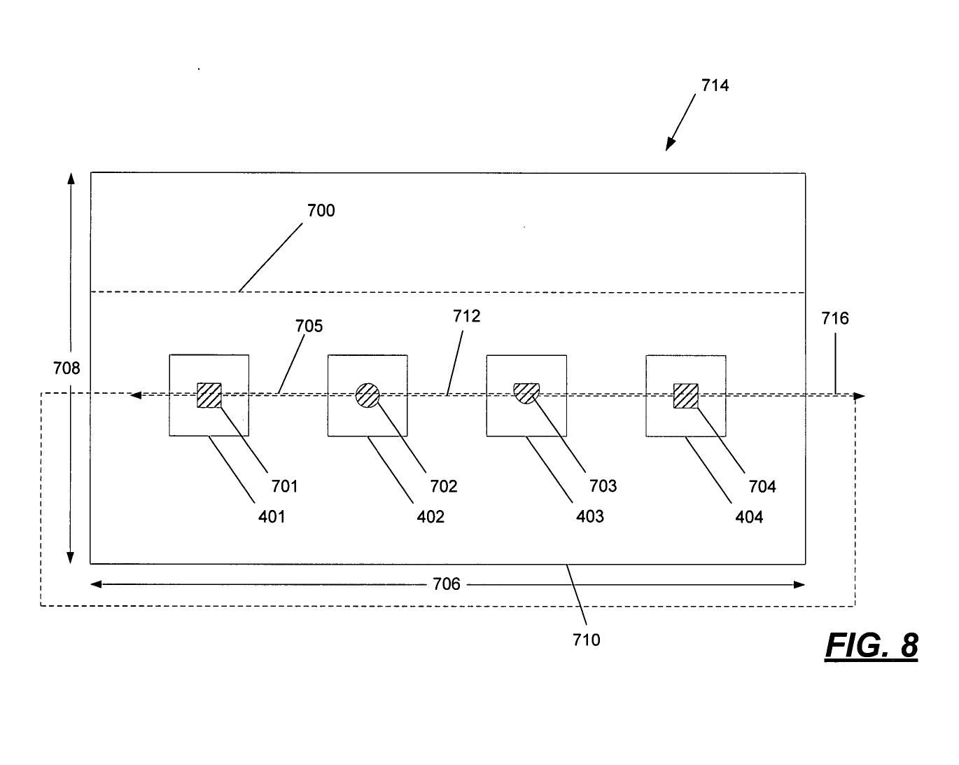

Prior to the activation of the bore 701, a plate is disposed in slot 202 through slot opening 710. As depicted in FIG. 2, the plate enters slot 202 from the side of slot opening 710. In one embodiment, slot 202 extends only partially into base 305, and thus has an inner slot edge 700. In another embodiment, the slot 202 runs the entire depth of base 305. Other slot configurations are illustrated in FIG. 7 and FIG. 8.

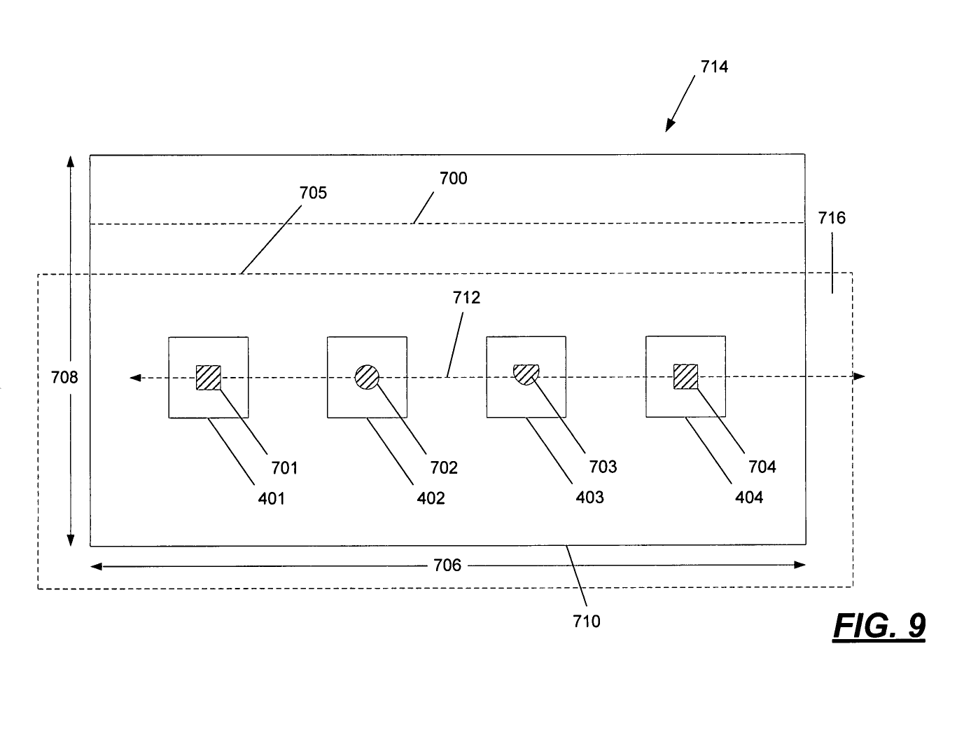

FIG. 7 depicts footprint 714 of base 305 (see FIG. 4) wherein plate 716 (shown in phantom) is disposed in slot 202 (see FIG. 4). Footprint 714 has depth 708 and length 706. In one embodiment, length 706 is less than about 40 centimeters. In another embodiment, the length 706 is less than about 25 centimeters. In yet another embodiment, the length 706 is from about 14 centimeters to about 20 centimeters. First bore 701, second bore 702, third bore 703, and fourth bore 704 are co-linear such that they form bore line 712. It is desirable that bore line 712 be parallel to inner plate edge 705. In the embodiment depicted, the inner plate edge 705 of plate 716 is contiguous with inner slot edge 700. The resulting plate will have holes within the center of plate 716. In another embodiment, shown in FIG. 8, the inner plate edge 705 is not contiguous with inner slot edge 700, but bore line 712 is still parallel to inner plate edge 705. The resulting plate will have notches on the edge of plate 716. In yet another embodiment, the inner plate edge 705 is not contiguous with inner slot edge 700, but the holes will be within the center of plate 716. Reference may be had to FIG. 9.

As can be seen in FIG. 9, first bore 701 has a shape substantially different from second bore 702. Utilizing bores of various shapes permits several notching patterns to be made on the resulting plates. Should the user desire to produce additional notching patterns, the user may either add additional actuators and/or switch an existing bore for an alternate bore.

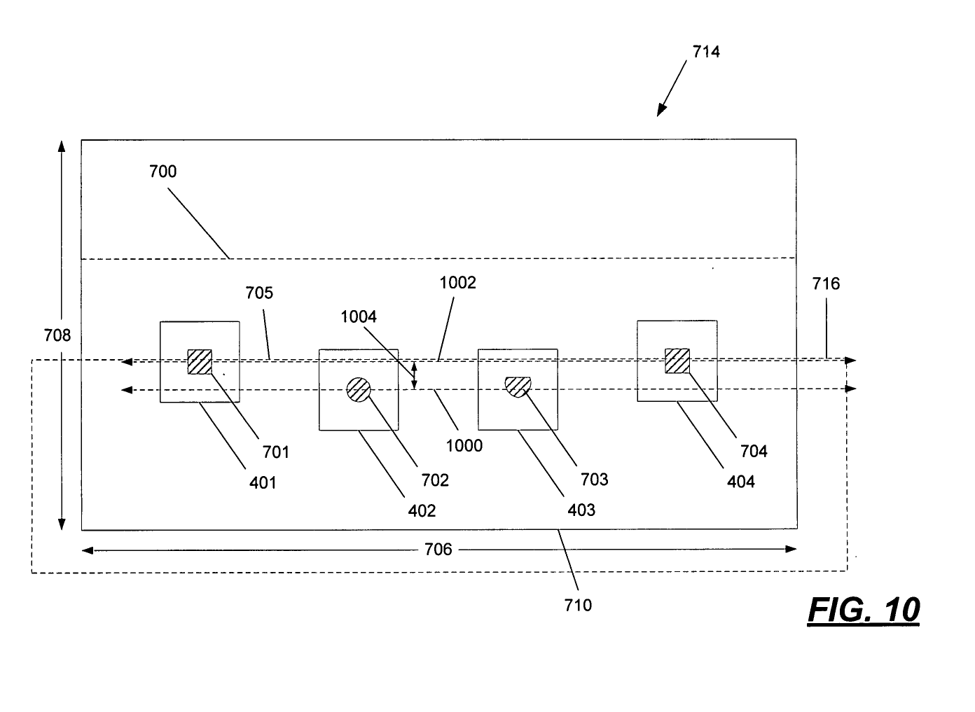

FIG. 10 is a depiction of footprint 714 that is similar to the footprint depicted in FIG. 8 except in that chaff disposal openings 403 and 404, as well as bore 702 and 703, have be moved away from inner slot edge 700. Such a configuration allows the user to punch two holes on the edge of plate 716 (with bores 701 and 704) and also punch two holes which are not on the edge of plate 716 (with bores 702 and 703). In such embodiments, at least two bores (such as bore 701 and 704) pass through first bore line 1000, which is parallel to inner plate edge 705. At least two additional bores (such as bores 702 and 703) pass through second bore line 1002. In the embodiment depicted, first bore line 1000 and second bore line 1002 are parallel. First bore line 1000 is a first distance away from inner plate edge 705. In the embodiment depicted, this first distance is substantially zero, thus the resulting hole is on the edge of plate 716. Other measurements of the first distance are also contemplated for use with this invention. Second bore line 1002 is a second distance 1004 away from inner plate edge 705, such that the second distance is greater than the first distance. In this manner, the resulting hole is not on the edge of plate 716. In another embodiment, not shown, such first and second bore lines are not parallel.

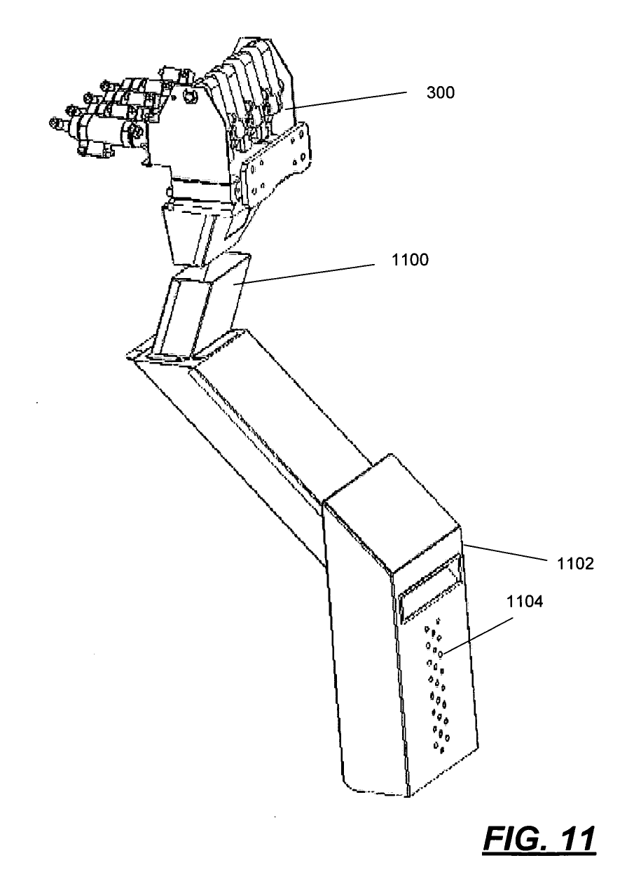

One advantage of the plate punching assembly 300 of this invention is the safe and easy collection of the chaff produced during the punching process. Since the assembly of the present invention is substantially more compact than prior art assemblies, the entire footprint 714 (see FIG. 7) may be disposed over a collection shaft that terminates in a collection container. Reference may be had to FIG. 11.

FIG. 11 is an illustration of the computer-to-plate assembly 100 of FIG. 1 from the rear. Plate punching assembly 300 has been disposed over collection shaft 1100. Collection shaft 1100, which is disposed within supporting structure 122 (see FIG. 1) terminates in collection container 1102. Container 1102 has viewing ports 1104 that permit the user to determine if the container is full of chaff. Container 1102 is disposed external to supporting structure 122 (see FIG. 1) and can be removed from such supporting structure 122 and emplied without interrupting the operation of assembly 100. In one embodiment, the entire path of the chaff is sealed such that no chaff has any opportunity to escape and interrupt the operation of assembly 100.

It is therefore, apparent that there has been provided, in accordance with the present invention, a method and apparatus for punching a notch in a printing plate. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. A plate punching assembly, comprising;
a. a base with a footprint that has a footprint length, wherein said base has a slot configured to receive a printing plate with an inner edge, wherein said footprint is comprised of a first chaff disposal opening and a second chaff disposal opening;
b. a first bore and a first actuator configured to actuate said first bore, thus punching through said slot and into said first chaff disposal opening; and
c. a second bore and a second actuator configured to actuate said second bore, thus punching through said slot and into said second chaff disposal opening, wherein each of said bores are configured to be independently actuated.

2. The plate punching assembly as recited in claim 1, wherein said footprint length is less than about 40 centimeters.

3. The plate punching assembly as recited in claim 1, wherein said footprint length is less than about 25 centimeters.

4. The plate punching assembly as recited in claim 2, wherein said first bore and said second bore are co-linear such that they form a bore line that is parallel to said inner edge of said printing plate.

5. The plate punching assembly as recited in claim 2, wherein said footprint of said base is further comprised of a third chaff disposal opening and a third actuator configured to actuate a third bore that punches through said slot and into said third chaff disposal opening.

6. The plate punching assembly as recited in claim 5, wherein said footprint of said base is further comprised of a fourth chaff disposal opening and a fourth actuator configured to actuate a fourth bore that punches through said slot and into said fourth chaff disposal opening.

7. The plate punching assembly as recited in claim 6, wherein at least two of said bores are co-linear such that they form a first bore line that is parallel to said inner edge of said printing plate such that said first bore line is a first distance away from said inner edge of said printing plate.

8. The plate punching assembly as recited in claim 7, wherein two of said bores are co-linear such that they form a second bore line that is a second distance away from said inner edge of said printing plate, such that said second distance is greater than said first distance and said second bore line is parallel to said first bore line.

9. The plate punching assembly as recited in claim 6, wherein at least three of said bores are co-linear such that they form a first bore line that is parallel to said inner edge of said printing plate such that said first bore line is a first distance away from said inner edge of said printing plate.

10. A plate punching assembly, comprising;
a. a base with a footprint that has a footprint length, wherein said base has a slot configured to receive a printing plate with an inner edge, wherein said footprint is comprised of a first chaff disposal opening, a second chaff disposal opening, a third chaff disposal opening, and a fourth chaff disposal opening;
b. a first bore and a first actuator configured to actuate said first bore, thus punching through said slot and into said first chaff disposal opening;
c. a second bore and a second actuator configured to actuate said second bore, thus punching through said slot and into said second chaff disposal opening;
d. a third bore and a third actuator configured to actuate said third bore, thus punching through said slot and into said third chaff disposal opening;
e. a fourth bore and a fourth actuator configured to actuate said fourth bore, thus punching through said slot and into said fourth chaff disposal opening; wherein
f. each of said bores are configured to be independently actuated and wherein said first, second, third, and fourth bores are co-linear such that they form a bore line that is parallel to said inner edge of said printing plate.

11. The plate punching assembly as recited in claim 10, wherein said first actuator is mechanically connected to said first bore by a linkage.

12. The plate punching assembly as recited in claim 11, wherein said linkage is comprised of a horizontal stroke member and a vertical stroke member, wherein said horizontal stroke member and said vertical stroke member have a stroke ratio of from about 0.1 to about 5.

13. The plate punching assembly as recited in claim 12, wherein said stroke ratio is from about 0.1 to about 1.

14. The plate punching assembly as recited in claim 10, wherein said slot has an upper flange and a lower flange for guiding said printing plate into said slot.

15. The plate punching assembly as recited in claim 10, wherein said plate punching assembly is disposed within a computer-to-plate imager.

16. The plate punching assembly as recited in claim 10, further comprising a chaff collection shaft connected to said footplate such that chaff from said printing plate passes through a chaff disposal opening and into a chaff collector, wherein said chaff disposal opening is selected from the group consisting of said first chaff disposal opening, said second chaff disposal opening, said third chaff disposal opening, said fourth chaff disposal opening, and combinations thereof.

17. A process for punching a printing plate comprising;
a. disposing a printing plate with an inner edge into a slot of a plate punching assembly, wherein said plate punching assembly is comprised of;
i. a base with a footprint that has a footprint length, wherein said base is comprised of said slot configured to receive said printing plate, wherein said footprint of said base is comprised of a first chaff disposal opening and a second chaff disposal opening;
ii. a first bore and a first actuator configured to actuate said first bore, thus punching through said slot and into said first chaff disposal opening; and
iii. a second bore and a second actuator configured to actuate said second bore, thus punching through said slot and into said second chaff disposal opening, wherein each of said bores configured to be independently actuated;
b. moving said printing plate such that a first predetermined location is disposed beneath said first bore;
c. actuating said first actuator, thus producing a first hole in said printing plate;
d. moving said printing plate such that a second predetermined location is disposed beneath said second bore;
e. actuating said second actuator, thus producing a second hole in said printing plate.

18. The process for punching a printing plate as recited in claim 17, wherein said first bore and said second bore are co-linear such that they form a bore line that is parallel to said inner edge of said printing plate.

19. The process for punching a printing plate as recited in claim 18, wherein said footprint length is less than about 40 centimeters.

20. The process for punching a printing plate as recited in claim 19, wherein said plate punching assembly is further comprising a chaff collection shaft connected to said footplate such that chaff from said printing plate passes through a chaff disposal opening and into a chaff collector, wherein said chaff disposal opening is selected from the group consisting of said first chaff disposal opening, said second chaff disposal opening, and combinations thereof.
